(19) United States
(12) Patent Application Publication
(10) Pub. No.: US 2025/0335851 A1
(43) Pub. Date: Oct. 30, 2025

(54) Systems and methods for automatically identifying a workflow for execution

(71) Applicant: Canva Pty Ltd, Surry Hills (AU)

(72) Inventor: Rafael Carvalhaes Possas, Gymea (AU)

(73) Assignee: Canva Pty Ltd, Surry Hills (AU)

(21) Appl. No.: 19/187,653

(22) Filed: Apr. 23, 2025

(30) Foreign Application Priority Data
Apr. 24, 2024 (AU) 2024202688

(51) Int. Cl. G06Q 10/0633; G06F 16/242

(52) U.S. Cl. CPC G06Q 10/0633; G06F 16/243

(57) ABSTRACT

Described herein is a computer implemented method for automatically identifying a workflow. The method includes: receiving input data defining a support query and processing the input data to generate a classifier input for a classifier based on the input data, wherein the classifier is a trained machine learning model. The method further includes processing, by the classifier, the classifier input to identify a first workflow from a plurality of workflows, wherein the first workflow defines one or more workflow actions which can be executed in response to the support query.

### CROSS-REFERENCE TO RELATED APPLICATION

This application is a U.S. Non-Provisional Application that claims priority to Australian Patent Application No. 2024202688, filed Apr. 24, 2024, which is hereby incorporated by reference in its entirety.

### TECHNICAL FIELD

Aspects of the present disclosure are directed to systems and methods for automatically identifying a workflow for execution based on a support request.

### BACKGROUND

Technical support is common across many industries, in particular for proprietors of products such as electronic and computing devices and software-based products. Technical support traditionally involves a support technician fielding queries from a user or buyer of a product in respect of issues they may be having with the product. Such issues include malfunctions of the product itself, and users or buyers wanting instructional help on how to use certain features of a product.

For common queries or issues, there may be predefined workflows that have been formulated to resolve, attempt to resolve or help to resolve such queries or issues. When a common query or issue is received, a support technician will determine if a relevant predefined workflow has been defined and, if so, respond to the query by based on the workflow. Predefined workflows may include a series of actions that are either performed automatically or with input from the support technician, such as gathering certain information and completing certain tasks that have been known to at least help to identify and/or resolve a certain issue.

Technical support solutions that are well-known in the art may not be scalable. In particular they may not be conducive to scaling up as this may necessitate additional human interactions from support technicians. Reliance on support technicians may affect efficiencies in respect of addressing queries or issues that may be raised by users in a timely fashion. Without such critical human interactions, the efficacy of technical support solutions that are well-known in the art may be significantly diminished.

Background information described in this specification is background information known to the inventors. Reference to this information as background information is not an acknowledgment or suggestion that this background information is prior art or is common general knowledge to a person of ordinary skill in the art.

### SUMMARY

Described herein is a computer implemented method for automatically identifying a workflow including: receiving input data defining a support query; processing the input data to generate a classifier input for a classifier based on the input data, wherein the classifier is a trained machine learning model; and processing, by the classifier, the classifier input to identify a first workflow from a plurality of workflows, wherein the first workflow defines one or more workflow actions which can be executed in response to the support query.

### BRIEF DESCRIPTION OF THE DRAWINGS

In the drawings:

FIG. 1 is a diagram depicting a networked environment in which various features of the present disclosure may be implemented.

FIG. 2 is a block diagram of a computer processing system configurable to perform various features of the present disclosure.

FIG. 3 depicts an example workflow shown graphically.

FIG. 4 depicts operations performed in a method for automatically identifying a workflow for execution.

FIG. 5 depicts operations performed in an alternate method for automatically identifying a workflow for execution.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

As discussed above, technical support is available for many types of products. Such products include, for example, electronic devices (such as smart phones and computer devices), computer software-based products (including subscription-based services), and other products. In some instances, technical support services may be provided by the developer/manufacturer of the product and access to the technical support is provided as part of the sale of or subscription to that product. In other cases, technical support services may be provided by a third party.

Technical support services are typically facilitated by a technical support application. Technical support applications typically provide one or more user support channels via which a user can raise (or submit) a query or issue and support can be provided. For instance, a query may be in relation to a user being unable to access a certain feature of the product and this may be due to a technical issue that requires a fix. On the other hand, a query may be in relation to how to use a certain feature of the product, which is not an issue that requires fixing but simply a helpful response as to how to use that feature.

For certain queries or issues, as discussed above, the support application may include (or have access to) predefined workflows that define a series of actions that can be performed to try and address the query or issue. These predefined workflows assist support technicians to resolve or attempt to resolve specific queries that a user of a product may have. In known support systems, support technicians (i.e. human users) review a user query and based thereon manually select an appropriate workflow that can be implemented to address the query. For example, a workflow action of one workflow might be for a support technician to check an account database to see if a user's subscription is current. If it is determined that the user's subscription is not current, the next action might be for the support technician to generate a communication informing the user they are not subscribed and communicating this to the user. Thus, in known support systems, there is a need for human interaction to select a workflow as well as to commence that workflow and this may present efficiency issues (due to, for example, the man hours required to select and complete a workflow) and scalability issues (due to, for example, an increase in user leading to an increase in user queries which require an increase in support technician time to handle these queries).

The present disclosure is directed to systems and methods for automatically identifying a workflow for execution. The techniques disclosed herein are described in the context of a technical support application that can be used with any product where a user of that product may require technical support. One such product may be a digital design platform that is configured to facilitate various operations concerned with digital designs. For example, techniques herein may be used in the context of receiving, actioning and responding to a query from a user of a digital design platform. Example of types of support queries that may arise in respect of digital design platforms include: product feature help type queries such as how to perform a certain design operation (e.g. how to add an image to a design, how to recolour a graphic, how to publish a design as a website); product feature fault type queries such as reporting that a certain design operation is not working properly; and administrative queries such as how to cancel/renew subscription, how to change password. However, the techniques may be equally applicable to other tasks in respect of digital design platforms that utilise workflows, such as implementing certain features of digital design platforms (e.g. configuring one or more aspects of a digital design using a setup wizard/software assistant). Further, the techniques may be equally applicable to any platform that utilises workflows.

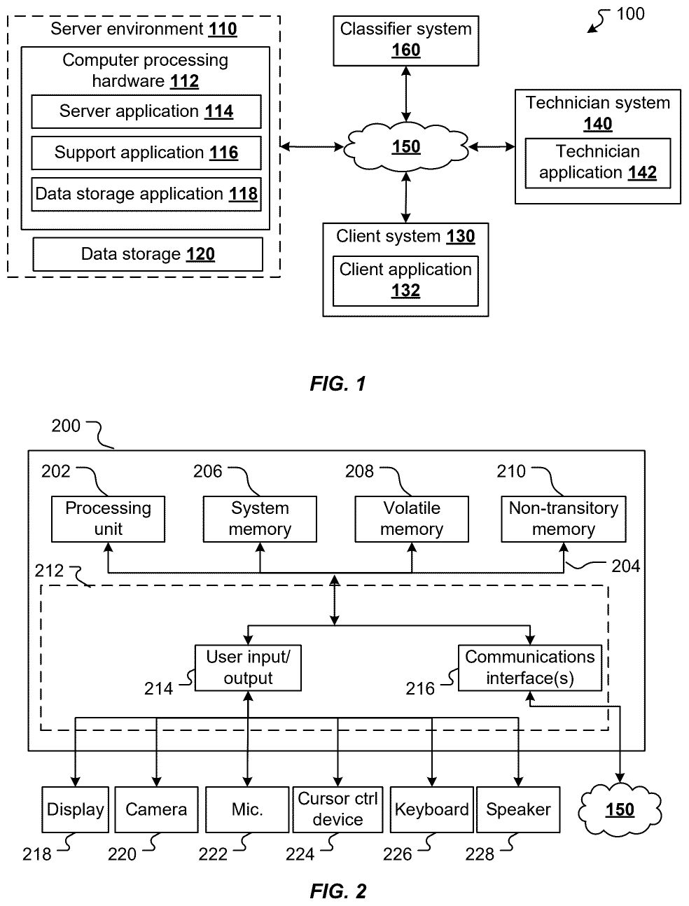

FIG. 1 is a diagram depicting a networked environment 100 in which various features of the present disclosure may be implemented.

Networked environment 100 includes a server environment 110, a client system 130, and a technician system 140 which communicate via one or more communications networks 150 (e.g. the Internet).

Generally speaking, the server environment 110 includes computer processing hardware 112 (discussed below) on which applications that provide server-side functionality to client applications such as client application 132 (described below) and technician applications such as technician application 142 (described below) execute. In the present example, server environment 110 includes a server application 114 (which may also be referred to as a front end server application), a support application 116 and a data storage application 118.

In the present embodiment, the server application 114 executes to provide a client application (and a technician application) endpoint that is accessible over communications network 150. For example, where server application 114 serves web browser client applications the server application 114 will be a web server which receives and responds (for example) to HTTP requests. Where server application 114 serves native client applications, server application 114 will be an application server configured to receive, process, and respond to specifically defined API calls received from those client applications. The server environment 110 may include one or more web server applications and/or one or more application server applications allowing it to interact with both web and native client applications.

In the present example, server application 114 (and/or other applications of server environment 110) facilitates various functions related to digital designs. These may include, for example, design creation, editing, storage, organisation, searching, storage, retrieval, viewing, sharing, publishing, and/or other functions related to digital designs. The server application 114 (and/or other applications) may also facilitate additional, related functions such as user account creation and management, user group creation and management, user and user group permission management, user authentication, and/or other server side functions.

In the present example, support application 116 facilitates various functions related to technical support of the digital design platform. These may include responding to user queries, actioning or arranging actioning of tasks to address user queries, and other technical support actions associated with the digital design platform. In other embodiments, support application 116 may be integrated with server application 114 such that the functions performed or facilitated by support application 116 are carried out by server application 114. In alternative embodiments, the functionality described herein of support application 116 may be in part provided by server application 114 and in part provided by support application 116.

In the present example, the data storage application 118 executes to receive and process requests to persistently store and retrieve data relevant to the operations performed/services provided by the server environment 110. Such requests may be received from the server application 114, support application 116, other server environment applications, and/or (in some instances) directly from client applications such as 132. Data relevant to the operations performed/services provided by the server environment 110 may include, for example, user account data, user design data (i.e. data describing designs that have been created by users), template design data (e.g. templates that can be used by users to create designs), design element data (e.g. data in respect of stock elements that users may add to designs), workflow data (e.g. predefined workflows) and/or other data relevant to the operation of the server environment 110.

The data storage application 118 may, for example, be a relational database management application or an alternative application for storing and retrieving data from data storage 120. Data storage 120 may be any appropriate data storage device (or set of devices), for example one or more non-transitory computer readable storage devices such as hard disks, solid state drives, tape drives, or alternative computer readable storage devices.

In server environment 110, server application 114 persistently stores data to data storage 120 via the data storage application 118. In alternative implementations, however, the server application 114 may be configured to directly interact with data storage devices such as 120 to store and retrieve data (in which case a separate data storage application may not be needed). Furthermore, while a single data storage application 118 is described, server environment 110 may include multiple data storage applications. For example one data storage application 118 may be used for user account data, another for user design data, another for design element data and so forth. In this case, each data storage application may interface with one or more shared data storage devices and/or one or more dedicated data storage devices, and each data storage application may receive/respond to requests from various server-side and/or client-side applications (including, for example server application 114).

As noted, the server environment 110 applications run on (or are executed by) computer processing hardware 112. Computer processing hardware 112 includes one or more computer processing systems. The precise number and nature of those systems will depend on the architecture of the server environment 110.

For example, in one implementation each server environment application may run on its own dedicated computer processing system. In an alternative implementation, two or more server environment applications may run on a common/shared computer processing system. In a further alternative implementation, server environment 110 is a scalable environment in which application instances (and the computer processing hardware 112—i.e. the specific computer processing systems required to run those instances) are commissioned and decommissioned according to demand—e.g. in a public or private cloud-type system. In this case, server environment 110 may simultaneously run multiple instances of each application (on one or multiple computer processing systems) as required by client demand. Where server environment 110 is a scalable system it will include additional applications to those illustrated and described. As one example, the server environment 110 may include a load balancing application which operates to determine demand, direct client traffic to the appropriate server application instance 114 (where multiple server applications 114 have been commissioned), trigger the commissioning of additional server environment applications (and/or computer processing systems to run those applications) if required to meet the current demand, and/or trigger the decommissioning of server environment applications (and computer processing systems) if they are not functioning correctly and/or are not required for current demand. Thus, scalability of the present systems (i.e. networked environment 100) and methods, for the most part, rely upon hardware limitation that can be adjusted based on usage requirements (i.e. the number of users) rather than primarily being reliant upon human interactions (i.e. man-hours).

Communication between the applications and computer processing systems of the server environment 110 may be by any appropriate means, for example direct communication or networked communication over one or more local area networks, wide area networks, and/or public networks (with a secure logical overlay, such as a VPN, if required).

Client system 130 hosts a client application 132 which, when executed by client system 130, configures the client system 132 to provide client-side functionality/interact with server environment 110 (or, more specifically, server application 114, support application 116 and/or other applications provided by server environment 110). Via client application 132, and as discussed in detail below, a user can access the various techniques described herein. In particular, client application 132 will provide one or more mechanisms that allow a user to submit a support query.

Client application 132 may be a general web browser application which accesses server application 114, support application 116 and/or other applications provided by the server environment 110 via an appropriate uniform resource locator (URL) and communicates with server application 114 via general world-wide-web protocols (e.g. http, https, ftp). Alternatively, client application 132 may be a native application programmed to communicate with respective applications provided by server environment 110 using defined application programming interface (API) calls and responses.

A given client system such as 130 may have more than one client application 132 installed and executing thereon. For example, a client system 130 may have a (or multiple) general web browser application(s) and a native client application.

Technician system 140 hosts a technician application 142 which, when executed by technician system 140, configures technician system 140 to provide functionality/interact with server environment 110 (or, more specifically, the server application 114, support application 116 and/or other applications provided by the server environment 110). Via technician application 142, and as discussed in detail below, a support technician can access the various techniques described herein. In particular, technician application 142 will provide one or more mechanisms that allow a support technician to respond to and address a support query from a user through executing an identified workflow.

Like client application 132, technician application 142 may be a general web browser application which accesses the server application 114, support application 116 and/or other applications provided by the server environment 110 via an appropriate uniform resource locator (URL) and communicates with the server application 114 via general world-wide-web protocols (e.g. http, https, ftp). Alternatively, technician application 142 may be a native application programmed to communicate with respective applications provided by server environment 110 using defined application programming interface (API) calls and responses. In some embodiments, technician application 142 may communicate directly with one or more client applications such as client application 132, for instance, if a support technician wishes to communicate with a user.

The present disclosure describes various operations that are performed by applications of the server environment 110, client application 132 and technician application 142. Generally speaking, however, operations described as being performed by a particular application (e.g. server application 114) could be performed by (or in conjunction with) one or more alternative applications, and/or operations described as being performed by multiple separate applications could in some instances be performed by a single application (e.g. operations described as being performed by support application 116 may be performed by server application 114).

While the embodiments described below make use of a client-server architecture, the techniques and processing described herein could be adapted to be executed in a stand-alone context—e.g. by an application (or set of applications) that run on a computer processing system and can perform all required functionality without need of a server environment or application.

Networked environment 100 may further include other third party systems, such as a classifier system 160 (discussed below). Classifier system 160 communicates with server environment 110, client system 130 and/or technician system 140 via network 150. In this embodiment, classifier system 160 is located remotely to both server environment 110, client system 130 and technician system 140. However, in other embodiments, classifier system 160 may be implemented as part of server environment 110. Further, in other embodiments, networked environment 100 may further include a plurality of third party systems.

The techniques and operations described herein are performed by one or more computer processing systems.

By way of examples, client system 130 and technician system 140 may each be any computer processing system which is configured (or configurable) by hardware and/or software—e.g. client application 132 and technician application 142 respectively—to offer respective client-side and technician support functionality. Client system 130 and technician system 140 may each be a desktop computer, laptop computer, tablet computing device, mobile/smart phone, or other appropriate computer processing system.

Similarly, the applications of server environment 110 are also executed by one or more computer processing systems (the computer processing hardware 112). Server environment computer processing systems will typically be server systems, though again may be any appropriate computer processing systems.

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, the connection between the device and system 200 may be via wired or wireless hardware and communication protocols, and may be a direct or an indirect (e.g. networked) connection.

Generally speaking, and depending on the particular system in question, devices to which system 200 connects include one or more input devices to allow data to be input into/received by system 200 and one or more output devices to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

As another example, where system 200 is a server computing device it may be remotely operable from another computing device via a communication network. Such a server may not itself need/require further peripherals such as a display, keyboard, cursor control device etc. (though may nonetheless be connectable to such devices via appropriate ports).

Alternative types of computer processing systems, with additional/alternative input and output devices, are possible.

System 200 also includes one or more communications interfaces 216 for communication with a network, such as network 150 of environment 100 (and/or a local network within the server environment 110). Via the communications interface(s) 216, system 200 can communicate data to and receive data from networked systems and/or devices.

System 200 stores or has access to computer applications (which may also be referred to as computer software or computer programs). Generally speaking, such applications include computer readable instructions and data which, when executed by the processing unit 202, configure system 200 to receive, process, and output data. Instructions and data can be stored on non-transitory machine readable medium such as non-transitory memory 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server environment 110 includes one or more systems which run a server application 114, a support application 116, and a data storage application 118. Similarly, client system 130 runs a client application 132 and technician system 140 runs a technician application 142.

In some cases part or all of a given computer-implemented method will be performed by system 200 itself, while in other cases processing may be performed by other devices in data communication with system 200.

In examples where the technical support application is used with a digital design platform, the digital design platform may be part of environment 100. In other examples, environment 100 may be a part of the digital design platform. In yet other embodiments, environment 100 may be the digital design platform. In yet other embodiments, environment 100 may be completely separate to the digital design platform.

Such a digital design platform may be accessed by subscribed users that use login details to access and use the digital design platform. Subscribed users have registered accounts having associated user account data (which may include personal details as well as contact details of the user associated with the account, and the subscription type) and user design data (which may include designs that have been created or imported by the user), and other associated data. A subscribed user may also have a subscription type that governs what functions of the digital design platform are accessible to a user. There may be multiple subscription types that each provide different levels of accessibly of the digital design platform. For example, a digital design platform may have a “pro” subscription type and a “free” subscription type whereby the free subscription type includes a subset of the accessible features of the pro subscription type. In other words the pro subscription type includes all features of the free subscription type as well as additional features not accessible for the free subscription type.

As also described above, support application 116 will have access to various workflows that have been defined in order to address commonly raised support queries. Workflows may be defined, represented, and/or stored in various ways. For example, workflows may generally be defined in a workflow markup language. One example of such a language is the Business Process Model and Notation (BPMN). Where a workflow is defined by a workflow markup language such as BPMN, the workflow can be defined in one or more configuration files, or other appropriate files. Workflows that are described in an appropriate workflow markup language can be processed to generate corresponding workflow graphs (for example, directed acyclic graphs (DAGs)). Furthermore, in certain implementations support application 116 can be configured to automatically perform certain actions defined in a workflow to address (or attempt to address) a support query. In embodiments, support application 116 can be configured to automatically perform all actions defined in a workflow.

Workflow graphs may additionally be used to provide a visual representation of a workflow, for example, for presenting to a support technician. Such visual representation of the workflow, may assist a support technician in responding to a support query.

In other embodiments, workflows described in an appropriate workflow markup language can be processed to generate those workflows in other desired forms, for example alternate text forms for visual display to an inexperienced human user where the workflow actions are expressed in lay terms.

By way of example, the following is a BPMN refund workflow that may be selected and executed if a user of a product or service requests a refund of their purchase or subscription price:

```
<?xml version=“1.0” encoding=“UTF-8”?>
<bpmn:definitions xmlns:xsi=“http://www.w3.org/2001/XMLSchema-instance”
xmlns:bpmn=“http://www.omg.org/spec/BPMN/20100524/MODEL”
xmlns:bpmndi=“http://www.omg.org/spec/BPMN/20100524/DI”
xmlns:dc=“http://www.omg.org/spec/DD/20100524/DC”
xmlns:di=“http://www.omg.org/spec/DD/20100524/DI”
targetNamespace=“http://bpmn.io/schema/bpmn”>
  <bpmn:process id=“RefundProcess” name=“Refund Process”>
  <bpmn:startEvent id=“startEvent”/>
  <bpmn:userTask id=“submitRefundRequest” name=“Submit Refund Request”/>
  <bpmn:userTask id=“receiveRequestVerify” name=“Receive Request and Verify
Purchase”/>
  <bpmn:exclusiveGateway id=“decision”/>
  <bpmn:userTask id=“informIneligibility” name=“Inform User of Ineligibility”/>
  <bpmn:userTask id=“processRefund” name=“Process Refund”/>
  <bpmn:userTask id=“confirmRefund” name=“Confirm Refund to User”/>
  <bpmn:endEvent id=“endEvent”/>
  <!-- Sequence Flows -->
  <bpmn:sequenceFlow sourceRef=“startEvent” targetRef=“submitRefundRequest”/>
  <bpmn:sequenceFlow sourceRef=“submitRefundRequest”
targetRef=“receiveRequestVerify”/>
  <bpmn:sequenceFlow sourceRef=“receiveRequestVerify” targetRef=“decision”/>
  <bpmn:sequenceFlow sourceRef=“decision” targetRef=“informIneligibility” name=“Not
Eligible”/>
  <bpmn:sequenceFlow sourceRef=“decision” targetRef=“processRefund”
name=“Eligible”/>
  <bpmn:sequenceFlow sourceRef=“informIneligibility” targetRef=“endEvent”/>
  <bpmn:sequenceFlow sourceRef=“processRefund” targetRef=“confirmRefund”/>
  <bpmn:sequenceFlow sourceRef=“confirmRefund” targetRef=“endEvent”/>
  </bpmn:process>
</bpmn:definitions>
```

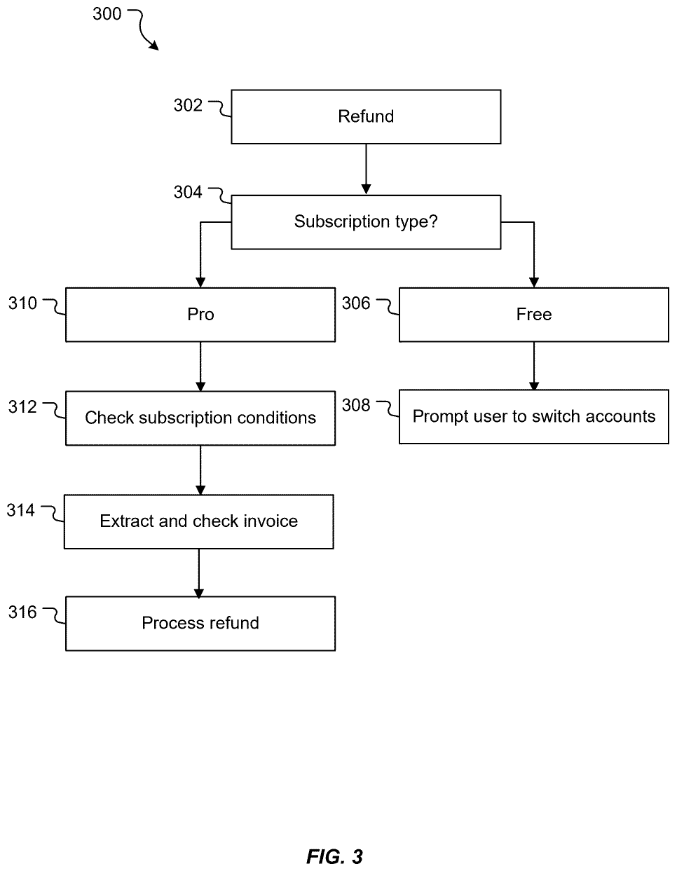

FIG. 3 provides a visual representation of the above BPMN refund workflow, that is, a corresponding refund workflow graph 300 of the refund workflow. Each step of workflow graph 300 depict actions that are to be performed. Each action may be performed automatically by environment 100 and/or by a support technician.

In this particular example, the execution of the workflow of workflow graph 300 commences at 302, i.e. the workflow is initiated. At 304, the subscription type of the user is determined. This determination is made by retrieving account data (for instance, stored in data storage 120) of the user making the request. From the account data, the subscription type of the user is retrieved. At 306, if the subscription type of the user is found to be “free” subscription type then, at 308, the user will be prompted to switch accounts (in case the user requesting the refund may have a different account that has a “pro” subscription type). This is one endpoint of this workflow.

At 310, if the subscription type of the user is found to be “pro” subscription type then, at 312, subscription conditions in respect of this account are checked. This includes checking whether there are any account conditions that may prohibit a refund. If there are such conditions, a support technician may be prompted to take an action before the refund is further processed. For example, if the user has requested multiple refunds within a certain time period, a support technician may be required to review the account, perhaps obtain more information from the user as to why multiple refunds have been requested and/or take other actions, before environment 100 can continue to process the present refund request.

Once it has been determined that there are no subscription conditions preventing the refund request from being processed further, at 314, an invoice associated with the previous payment is extracted and checked. This checking includes either determining a refund amount, or checking that an amount requested for refund by the user matches (or does not exceed) an amount on the associated invoice.

Once the invoice has been checked, at 316, the refund is then processed such that the relevant amount is returned to a bank account either specified by the user or recorded in account data.

In the present embodiments, each predefined workflow is associated with a workflow descriptor in the form of a textual description that semantically describes the workflow. For example, workflow 300 may have the following descriptor: “Select this flow if user requires a refund”. A workflow descriptor may have a character or word limit, for example up to 500 words. Each predefined workflow may also have a designated workflow label or identifier that is used to identify a predefined workflow. For example, workflow 300 may have the following label: “Refund process”. Each predefined workflow, including any data associated with a predefined workflow, may be stored in data storage 120. In other embodiments, each predefined workflow (including any associated data) may be stored in a storage other than data storage 120, for example within technician system 140 or within an accessible data storage external to environment 100, but in communication with environment 100 for example via network 150. In yet other embodiments, each predefined workflow (including any associated data) may be stored in one of several storage locations within and external to environment 100. In yet other embodiments, each predefined workflow (including any associated data) may be stored in more than one of the several storage locations, for example a primary storage may be data storage 120 and an identical backup version may be stored in an accessible data storage external to environment 100.

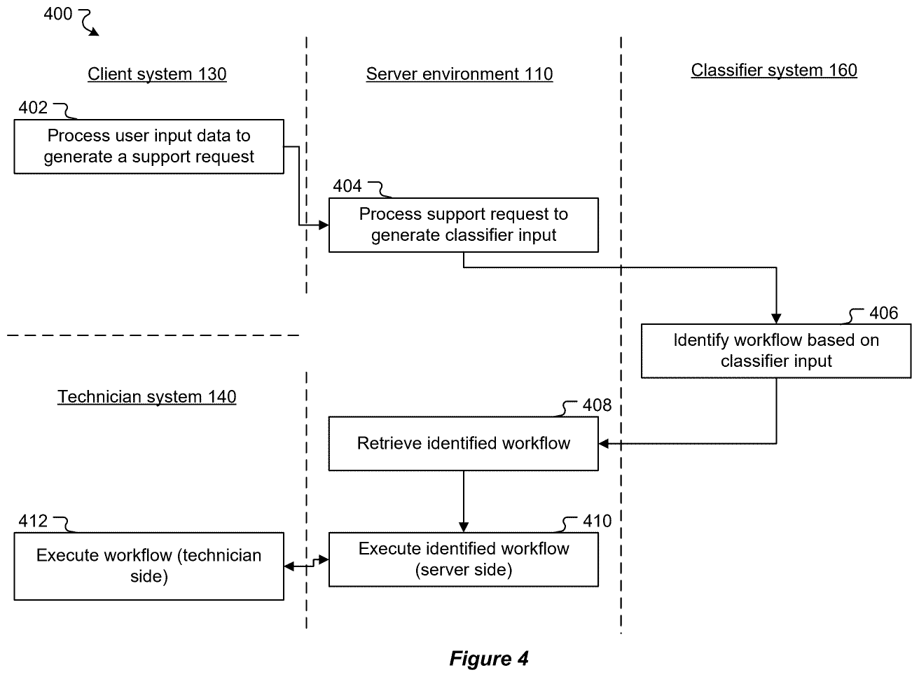

Turning to FIG. 4, a computer implemented method 400 for automatically identifying and executing a predefined workflow will be described. As noted above, the operations of method 400 will be described as being performed by client application 132 running on client system 130, technician application 142 running on technician system 140 and support application 116 at server environment 110, as well as classifier system 160. In alternative embodiments, however, the processing described may be performed by one or more alternative applications running on client system 130, technician system 140 and at server environment 110 and/or other computer processing systems.

At 402, client application 132 receives user input data that may define a support query. The user input data may be received in any appropriate format (e.g. text or audio) to at least one of a plurality of user support channels. Such user support channels include, for example, a dedicated webpage, a chat bot pop-up or embedded in product webpage, an instant messaging service, or an email. Client application 132 processes the user input data to generate a support request that includes the user input data. The support request may also include additional query data based on the user input data, for example, where the user input data is an audio input, other support data can include text generated based on audio input. The support request may also include (or otherwise be associated with or referenced to) additional context data for example, user identification data (a user or account identifier such as an email address of the user or associated with a user account) and/or context data (for instance, where the user is currently accessing a particular product page or feature of a product, the context data may include information in respect of that page/feature).

In some embodiments, the support request can include only the user input data in the form submitted by the user. In this case, the above processing of the user input data may be performed by support application 116 and/or server application 114.

In an example, the user input data includes an input string in the form of a textual query from a user that defines a user request. For example, in the context of a digital design platform, the user request may be querying why a certain function/feature of the digital design platform is not working or accessible. An example input string may therefore be: “I am having problems accessing some of my paid features.”

It will be appreciated that in various embodiments, client application 132 could be a dedicated client (user) support application or client application 132 could be the application of the product (e.g. a digital design platform) on which the user is seeking support that is configured to directly receive support queries.

Client application 132 then communicates the support request to server environment 110 (in particular to support application 116, though this may be server application 114).

At 404 the support request is received by server environment 110 and support application 116 processes the support request to generate a classifier input. This involves processing the support request to generate an appropriate classifier input for the classifier system 160 that is being used.

The specific processing performed to generate the classifier input, and the format of that input, will depend on the specific classifier system 160 that is used. In the present example, classifier system 160 is a machine learning model that is trained to process an input (e.g. a prompt such as a text string) and return an output (i.e. a suitable response to the inputted text string, such as a predefined workflow).

By way of a more specific example, in one embodiment the classifier system 160 may be (or make use of) a large language model (LLM). By way of example, the LLM may be an OpenAI LLM, or an alternative LLM. In this embodiment, the classifier input includes a prompt that is based on the input string and additional prompt generation data as described below. The prompt is generated so that the LLM will generate output in a desired form (e.g. a predefined workflow or data from which a predefined workflow can be identified).

In the present embodiment, support application 116 is configured to generate a prompt at 404 that is made up of a plurality of prompt components. Various prompt components may be used, and as will be appreciated by those skilled in the art the specific wording of each prompt component may be varied in order to improve or change the output provided by the LLM. By way of illustration only, the LLM prompt generated at 404 may be made up of components such as one or more of:
A context setting component that provides context to the LLM. This component may be a string such as “This is a technical support service in respect of the digital design platform”
An information basis setting component that defines the information basis from which the LLM output may be identified. This component may be a string such as “You have a list of workflows” along with a string listing workflow labels of a plurality of predefined workflows that are available to support application 116 such as “Available workflows are: refund process; pro feature not accessible; . . . ”. In other examples, the workflow descriptors will be listed in this component. Another example string of this component may be “You have access to user background information”.

Additional/alternative workflows may be defined and further text may be included to describe the characteristics of each workflow.
An output setting component that indicates to the LLM the output required. This component may be a string such as “Return a workflow”, “Return a workflow label” or “Return a workflow descriptor”.
An output rule setting component that provides rules to which the LLM must follow for identifying the LLM output. This component may be a string such as “Only use workflows from the list of workflows”.

The LLM prompt may be a zero-shot prompt. In other embodiments, the LLM prompt may be a few-shot prompt.

In yet other embodiments, the LLM may be a model specifically re-trained, for example, using a plurality of workflows and a number of example prompts having corresponding correct output workflows.

In other embodiments, there may be an additional processing step prior to 404 where the input string is processed by the support application 116 (or an alternative application) to generate a semantic representation of the user request. This processing step may be natural language processing or other suitable techniques. Support application 116 may then generate the prompt based on the semantic representation of the user request. Support application 116 then feeds the classifier input into classifier system 160. Additionally, support application 116 (or an alternative application) may cross check user identification data in the support request with user account data (e.g. via data storage application 118 retrieving user account data from data storage 120).

Once support application 116 has generated the classifier input (e.g. a prompt), it communicates the prompt to the classifier system 160.

At 406, classifier system 160 receives the classifier input from the support application 116. On receiving the classifier input, classifier system 160 processes the classifier input to identify a workflow from a plurality of predefined workflows. As described above, the identified workflow will include one or more workflow actions which can be executed to address or attempt to address the user request. In other embodiments, workflows may be identified using other secondary factors in addition to the user's intention as compared to the descriptors of each predefined workflow. For example, where there are two or more workflows that classifier system 160 may identify as equally or almost equally relevant to the user intent, historical data of the number of times a workflow has been called may also factor into the workflow that is ultimately identified by classifier system 160.

The output of classifier system 160 may include classifier output data that provides data that permits the predefined workflow that the classifier has identified to be identified and retrieved. Classifier system 160 then communicates the classifier output data to support application 116.

As described above, in the present example classifier system 160 is (or makes use of) a trained machine learning model, such as a large language model (LLM). In the LLM example described above, the classifier output data is the workflow descriptor. In alternate embodiments, and depending on how classifier system 160 is trained and the classifier input is generated at 404, the classifier output data may be other data that allows the workflow that the classifier has identified to be identified (and retrieved) by support application 116.

At 408, the classifier output data is received by support application 116. Based on the received classifier output data, server application 114 retrieves the workflow identified by the classifier, for example from data storage 120. Where classifier output data must be processed to recognise the identified workflow, support application 116 may carry out such processing before communicating with data storage application 118 to retrieve the identified workflow from data storage 120. As one example, this may involve converting the classifier output data (e.g. words of text or an identifier) into the workflow label or enum. For example, if the classifier output data is “Refund process”, support application 116 (and/or server application 114) may convert the response to an identifier corresponding to the “Refund process” workflow (which could be a numerical value or some other identifier). In examples where the classifier output data is a workflow descriptor (such as “Select this flow if user requires a refund”), support application 116 (and/or server application 114) may retrieve the identifier of that workflow (such as “Refund process”).

When one or more of the aforementioned prompt components is included, the resultant prompt may be optimised such that it increases the efficacy of the functioning of environment 100. This directly contributes to the generated classifier input causing classifier system 160 to provide classifier output data that enables retrieval of an identified workflow relevant to the support query. In other words, the prompt components are specific technical components of a prompt, the inclusion of which provides a prompt that is specifically formulated for obtaining the desired and best result from classifier system 160. Thus, the generated classifier input directly improves the use of classifier system 160. The generated classifier input thus includes technical components that directly contribute to the efficacy of the functioning of environment 100.

Once server application 114 has retrieved the identified workflow, at 410, support application 116 initiates execution of the workflow. Actions of the identified workflow may be carried out either: wholly within server environment 110 (e.g. by support application 116); or within server environment 110 (e.g. by support application 116) and, at 412, by technician system 140 (e.g. by technician application 142).

For instance, some workflow actions such as checking account data may be carried out automatically by support application 116 (e.g. by interacting with data storage application 118 and/or data storage 120).

Other actions of the identified workflow may, however, require further input from the user and/or a support technician. In this case, support application 116 may perform various steps to communicate with the user that submitted the support request (e.g. via client application 132) and/or a support technician (e.g. via technician application 142). For example, support application 116 may initiate a user session, for example, to request verification information from the user that submitted the request to check against account data in order to verify the user. Where the user support channel that received the support request are two way channels (such as a chat bot pop-up or an instant messaging service) the user session may take place via the same user support channel. In other examples the user session may take place via a different user support channel from which the support request was received. As another example, one or more workflow actions may require input from a support technician. In this case support application 116 may communicate with a support technician via technician application 142. As one example, support application 116 may cause technician application 142 to display to the support technician a visual representation of the workflow that has been identified (e.g. a workflow graph such as 300). From this graph the technician can see what actions are required to resolve (or attempt to resolve) the support query and provide input to perform or assist in the performance of those actions. Generally speaking, however, execution of the identified workflow will be driven automatically by support application 116 with user input being elicited only if input from a human user is required.

Where further input from the support technician is not required, 412 may be omitted or may be communicating and/or displaying the identified workflow to the support technician only. In yet other embodiments, execution of the workflow may only be commenced once approved by a support technician.

Advantageously, systems described herein can automatically identify a relevant workflow to address (or attempt to address) a user's support query based on a natural language input from the user, as opposed to a rules-based process to identify a relevant workflow. Furthermore, depending on the actions of the identified workflow, systems described herein may automatically execute part or all of the workflow.

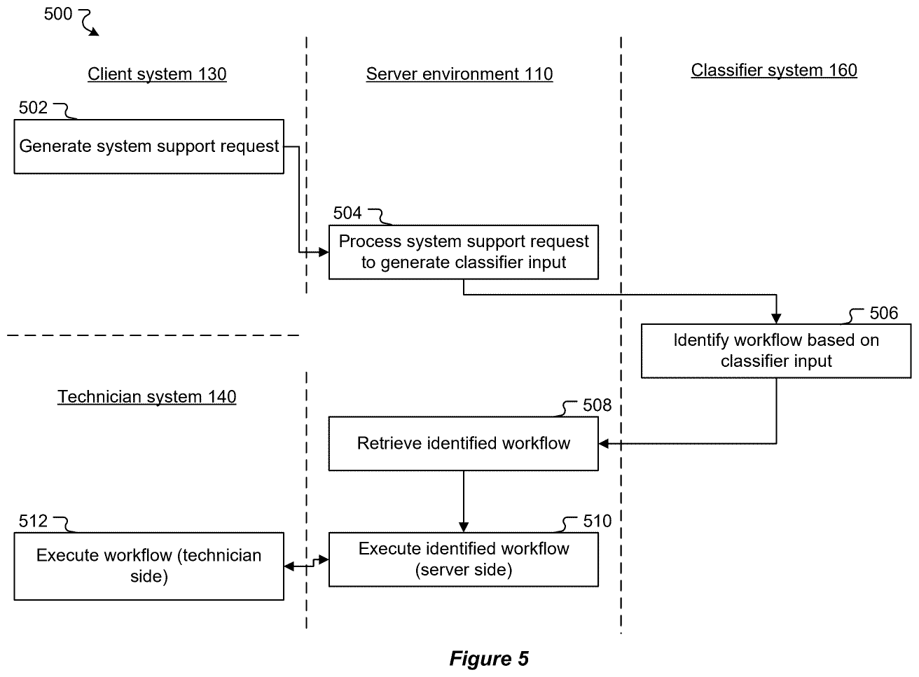

Referring to FIG. 5, another embodiment of a computer implemented method 500 for automatically identifying and executing a predefined workflow will be described. Method 500 is similar to method 400 with the exception that the support request is automatically generated and submitted. In some examples, this automatic generation and submission of the support request is a single combined action. As such, workflow identification (and execution) is automatically triggered rather than being triggered in response to a user input. Similar to method 400, the operations of method 500 will be described as being performed by client application 132 running on client system 130, technician application 142 running on technician system 140 and support application 116 running at server environment 110, as well as classifier system 160. In alternative embodiments, however, the processing described may be performed by one or more alternative applications running on client system 130, technician system 140 and at server environment 110 and/or other computer processing systems.

At 502, client application 132 generates a system support request. For example, in the context of a digital design platform, a certain event or series of events may cause client application 132 to generate a system support request. For example, if client application 132 detects that a user has unsuccessfully attempted to access a particular feature of the digital design platform a certain number of times it may be configured to generate a system support request based on system input data such as the following text string: “User cannot access feature X”. It will be appreciated that in embodiments where client system 130 has a dedicated client support application, 502 may be performed that dedicated client support application rather than client application 132. In such cases, the dedicated technical support application may directly communicate with support application 116 (and/or server application 114) or communicate with support application 116 (and/or server application 114) via client application 132.

The system support request may also include (or otherwise be associated with or referenced to) additional context data for example, user identification data (a user or account identifier such as an email address of the user or associated with a user account) and/or context data (for instance, where the user is currently accessing a particular product page or feature of a product, the context data may include information in respect of that page/feature).

Client application 132 communicates the system support request to server environment 110.

In other embodiments, 502 is performed at server environment 110 by support application 116 which generates the system support request. In this case, the certain event or series of events may cause client application 132 to communicate this to support application 116 to trigger generation of the system support request.

At 504, support application 116 processes the system support request, received by server environment 110 at 502 (or alternatively generated by server application 114), to generate a classifier input. 504 is similar to 404 with the exception that the 504 may be integrated with 502 such that the system support request is equivalent to the classifier input.

At 506, classifier system 160 receives the classifier input from the server application 114. 506 is identical to 406, and classifier system 160 communicates the classifier output data back to server environment 110.

At 508, the classifier output data is received by support application 116. Once support application 116 has retrieved the identified workflow, at 510, support application 116 initiates execution of the workflow. Actions of the identified workflow may be carried out either: wholly within server environment 110; or within server environment 110 and, at 512, by technician system 140. 508, 510 and 512 are identical to 408, 410 and 412 respectively. Similar to method 400, where further input from the support technician is not required, 512 may be omitted or may be communicating and/or displaying the identified workflow to the support technician only. In yet other embodiments of method 500, execution of the workflow may only be commenced once approved by a support technician.

Whilst above examples have mainly been in respect of addressing a user query in respect of technical support, techniques described herein may also be suitable to other applications. For example, techniques described herein may be used to drive contextual design help or creation in respect of the digital design platform. This may be done by fielding a user request to create a certain type of design, where an input string may be: “I want to create a congratulatory card for a work colleague.” Using the above techniques, this would be processed to generate a classifier input for an appropriate workflow to be identified that would assist the user to create the “congratulatory card” design.

In the above embodiments certain operations are described as being performed by the client system 130 (e.g. under control of the client application 132), the technician system 140 (e.g. under control of the technician application 142) and other operations are described as being performed at the server environment 110. Variations are, however, possible. For example in certain cases an operation described as being performed by client system 130 or technician system 140 may be performed at the server environment 110 and, similarly, an operation described as being performed at the server environment 110 may be performed by the client system 130 or the technician system 140. Generally speaking, however, where user input is required such user input is initially received at client system 130 (by an input device thereof) and where support technician input is required such support technician input is initially received at technician system 140 (by an input device thereof). Data representing that user or technician input may be processed by one or more applications running on client system 130 or technician system 140 respectively, or may be communicated to server environment 110 for one or more applications running on the server hardware 112 to process. Similarly, data or information that is to be output by a client system 130 or a technician system 140 (e.g. via display, speaker, or other output device) will ultimately involve systems 130 and 140, respectively. The data/information that is output may, however, be generated (or based on data generated) by client application 132, technician application 142 and/or the server environment 110 (and communicated to the client system 130 or technician system 140 to be output).

Furthermore, in certain implementations a computer processing system 200 may be configured (by an application running thereon) to perform the processing described herein entirely independently of a server environment 110. In this case, the application running on that system is a stand-alone application and all instructions and data required to perform the operations described above are stored on that system.

Systems and methods described herein provide a technically advantageous solution by enhancing the scalability, efficacy and efficiency in comparison to well-known systems and methods. In particular, generating a specific classifier input in response to a support request provides an optimal input to classifier system 160 that provides an optimal output from classifier system 160. The optimal output, in the form of classifier output data, is used by server environment 110 to retrieve an identified workflow that addresses the support request. This provides improved efficacy and in particular improved use of classifier system 160. Furthermore, systems and methods described herein offer improved efficiencies through the automated initiation of execution of the workflow. Whilst known systems may require input from a support technician to commence a workflow (and throughout the steps of the workflow), the efficacy of the system provides the further effect of being suitable for commencing a workflow once it has been retrieved without human interaction. Such an automated commencement may not be suitable for well-known systems where a workflow must be manually approved for commencement by a support technician as it may not be appropriate in response to the relevant support query. Thus, even if well-known systems are able to initiate a workflow, this is not a step that would conventionally be taken without input from a support technician. This automatic commencement would only contemplated based on the optimal output from classifier system 160 the present systems and methods provide.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method for automatically identifying a workflow including:
receiving input data defining a support query, the input data being in natural language;
processing the input data to generate a classifier input for a classifier based on the input data, wherein the classifier is a trained machine learning model and wherein the classifier input is a prompt including a context setting components and one or more of:
an information basis setting component;
an output setting component; and
an output rule component; and
processing, by the classifier, the classifier input to identify a first workflow from a plurality of workflows, wherein the first workflow defines one or more workflow actions which can be executed in response to the support query.

2. The computer implemented method according to claim 1, wherein the trained machine learning model is a natural language processing model.

3. The computer implemented method according to claim 2, wherein the natural language processing model is a large language model (LLM) and the classifier input is an LLM prompt.

4. The computer implemented method according to claim 3, wherein the LLM prompt is a zero-shot prompt.

5. The computer implemented method according to claim 1, wherein the input data is an input string.

6. The computer implemented method according to claim 5, wherein the input data is processed to generate the input string.

7. The computer implemented method according to claim 1, wherein the input data is based on an audio input.

8. The computer implemented method according to claim 1, further including executing the first workflow, wherein executing the first workflow includes automatically performing a first workflow action.

9. The computer implemented method according to claim 8, wherein executing the first workflow includes:
requesting first information from a user;
receiving the first information from the user; and
performing a second workflow action based on the first information.

10. The computer implemented method according to claim 9, wherein the user is the user that submitted the user request.

11. The computer implemented method according to claim 9, wherein the user is a support technician.

12. The computer implemented method according to claim 11, wherein executing the first workflow includes causing a visual representation of the first workflow to be displayed to the support technician.

13. The computer implemented method according to claim 8, wherein executing the first workflow includes automatically performing all of the workflow actions.

14. The computer implemented method according to claim 1, wherein processing the input string to generate a support request, wherein the support request is based on the input string and additional query data, and the classifier input is based on the support request.

15. The computer implemented method according to claim 14, wherein the additional query data includes one or more of: user identification data; and context data.

16. The computer implemented method according to claim 1, wherein the classifier input includes a plurality of descriptors each corresponding to one of the plurality of workflows.

17. The computer implemented method according to claim 1, wherein the classifier identifies the first workflow by returning a descriptor associated with the first workflow.

18. The computer implemented method according to claim 1, wherein the classifier identifies the first workflow by returning an identifier associated with the first workflow.

19. A computer processing system including:
a processing unit;
a communication interface; and
a non-transitory computer-readable storage medium storing instructions, which when executed by the processing unit, cause the processing unit to perform a method according to claim 1.

20. A non-transitory storage medium storing instructions executable by processing unit to cause the processing unit to perform a method according to claim 1.
